(19) United States
(12) Patent Application Publication
(10) Pub. No.: US 2007/0253312 A1
(43) Pub. Date: Nov. 1, 2007

(54) Optical Storage Interface Aparatus

(75) Inventors: Juil Lee, Eindhoven (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,539

(22) PCT Filed: Sep. 22, 2005
(86) PCT No.: PCT/IB05/53118

§ 371 Date: Apr. 3, 2007

(30) Foreign Application Priority Data
Oct. 8, 2004 (EP) 04300668.3

(51) Int. Cl. G11B 7/00

(52) U.S. Cl. 369/112.23

(57) ABSTRACT

In an optical storage interface apparatus, a spot-forming lens projects a light spot on an optical information carrier in response to a light beam from a light source. There is an air gap (AG) between the spot-forming lens and the optical information carrier. A gap detector (PHD2) provides a gap indication signal (GIS) that varies with the air gap (AG) in accordance with a gap indication transfer function (F). A lens-positioning arrangement (CTRL, ACT) positions the spot-forming lens with respect to the optical information carrier on the basis of the gap indication signal (GIS). The lens-positioning arrangement (CTRL, ACT) comprises a compensator (CMP) for compensating nonlinearity in the gap indication transfer function (F). A suitable compensation transfer function (G) can be established on the basis of servo control loop measurements. Accordingly, compensation can be provided without any prior knowledge of the gap indication transfer function (F).

### FIELD OF THE INVENTION

An aspect of the invention relates to an optical storage interface apparatus. The optical storage interface apparatus may be, for example, a digital versatile disk (DVD) player, which can read data from a DVD disk, or a DVD recorder, which can also write data onto a DVD disk. The optical storage interface apparatus may comprise, for example, a near-field optical system, which allows high density data readout and storage. Other aspects of the invention relate to a method of controlling an optical storage interface, and a computer program product for an optical storage interface.

### BACKGROUND OF THE INVENTION

The article entitled “Near-Field Optics: A New tool for Data Storage” by Tom D. Milster, IEEE proceedings, Vol. 88, No. 9, September 2000, pages 1480-1490, describes that near-field optical systems use evanescent energy to produce extremely small optical spots. Two practical implementations that use evanescent energy are aperture probes and solid immersion lenses. For both implementations, an optical recording layer must be in proximity to a coupling surface. For aperture probes, the coupling surface is an aperture of such a probe. For solid immersion lenses, the coupling surface is a flat surface of such a lens. Without close proximity, the spot size increases and the total energy available for coupling into the recording layer decreases due to evanescent decay.

A solid immersion lens can be mounted in a slider, which to some extent is similar to sliders used in magnetic hard drives. As an optical disk spins, the slider rides on an air bearing that separates the solid immersion lens from the optical recording layer by an air gap of thickness h.

### SUMMARY OF THE INVENTION

According to an aspect of the invention, an optical storage interface apparatus has the following characteristics. A spot-forming lens projects a light spot on an optical information carrier in response to a light beam from a light source. There is an air gap between the spot-forming lens and the optical information carrier. A gap detector provides a gap indication signal that varies with the air gap in accordance with a gap indication transfer function. A lens-positioning arrangement positions the spot-forming lens with respect to the optical information carrier on the basis of the gap indication signal. The lens-positioning arrangement comprises a compensator for compensating a nonlinearity in the gap indication transfer function.

The invention takes the following aspects into consideration. It is generally believed that gap indication transfer functions are substantially linear. A gap indication transfer function indeed appears to be substantially linear if a conventional measurement is made. In a conventional measurement, a gap indication signal is measured for air gaps, which range up to several hundreds of nanometers or even up to a few micrometers. The gap indication transfer function appears to be a substantially straight line if a graph is made.

The inventors of the present invention have succeeded in measuring gap indication transfer functions with a relatively high resolution for air gaps, which range up to a few tens of nanometers only. The inventors discovered that gap indication transfer functions are substantially nonlinear in such a range of relatively small air gaps, which may be comprised, for example, between 0 and 50 nanometers. In such an air gap range, the gap indication transfer function has a first derivative whose magnitude varies to a relatively great extent, although the sign of the first derivative remains constant.

In accordance with the aforementioned aspect of the invention, a lens-positioning arrangement comprises a compensator for compensating a nonlinearity in the gap indication transfer function.

The lens positioning arrangement forms part of a servo control loop, which further includes a gap detector. Compensating the nonlinearity in the gap indication transfer function allows the servo control loop to have a substantially similar dynamic behavior over a range of relatively small air gaps, which are typical for near-field optical systems. The dynamic behavior is a compromise between disturbance rejection, on the one hand, and stability margin, on the other hand. Consequently, compensating the nonlinearity in the gap indication transfer function allows a satisfactory disturbance rejection as well as a satisfactory stability margin over a range of relatively small air gaps. This allows reliable and robust data readout and data recording in near-field optical systems.

Another advantage of the invention relates to the following aspects. A slider of the type that is used in magnetic hard drives relies on an air-bearing surface with positive and negative pressure pockets. These pressure pockets build up pressure on which the slider floats so that there is an air gap between the slider and a disk, which is spinning. In practice, there will be dust, debris and other contamination in the pressure pockets. This can be an important reason for failure, in particular in an ordinary environment. The air gap may become too large or too narrow, which will affect readout or recording of data. The slider may even hit the disk. In that case, a thin leaf spring suspension, to which the slider is generally coupled, may get damaged. This is a major incident. Any readout or recording of data will no longer be possible until repair.

In accordance with the aforementioned aspect of the invention, the spot-forming lens is positioned with respect to an optical information carrier on the basis of a gap indication signal. The invention does not rely on pressure pockets to achieve a relatively small air gap. Instead, the invention uses an active control that seeks to maintain a constant, relatively small air gap. It has been observed that such an active control is less sensitive to dust, debris, and other contamination than a slider-based solution as in the prior art described hereinbefore. This further contributes to reliable and robust data readout and data recording. Furthermore, data readout or data recording can take place in a less protective environment compared with a slider-based solution as in the prior art. Protection against dust, debris, and other contamination generally involves costs. The aforementioned active control thus allows cost savings with regard to such protection. These cost savings will generally outweigh any additional costs associated with additional hardware or software, or both, which may be required compared with a slider-based solution.

These and other aspects of the invention will be described in greater detail hereinafter with reference to drawings.

### BRIEF DESCRIPTION OF THE DRAWINGS

FIG. 1 is a block diagram that illustrates an optical disk player.

FIG. 2 is a block diagram that illustrates an electro-optical interface, which forms part of the optical disk player.

FIG. 3 is a block diagram that illustrates a servo control loop, which is formed by the electro-optical interface and a controller, the servo control loop being in a control mode.

FIG. 4 is a graph that illustrates a gap indication transfer function in accordance with which a gap indication signal varies with an air gap between a solid immersion lens in the electro-optical interface and an optical disk.

FIG. 5 is a graph that illustrates a compensation transfer function, which compensates nonlinearity in the gap indication transfer function.

FIG. 6 is a block diagram that illustrates the servo control loop in a measurement mode.

FIG. 7 is a flow chart diagram that illustrates a measurement procedure which the controller carries out so as to establish the compensation transfer function.

FIG. 8 is a graph that illustrates the compensation transfer function, which has been established in accordance with the measurement procedure.

FIG. 9 is a flow chart diagram that illustrates an alternative measurement procedure.

### DESCRIPTION OF THE PREFERRED EMBODIMENTS

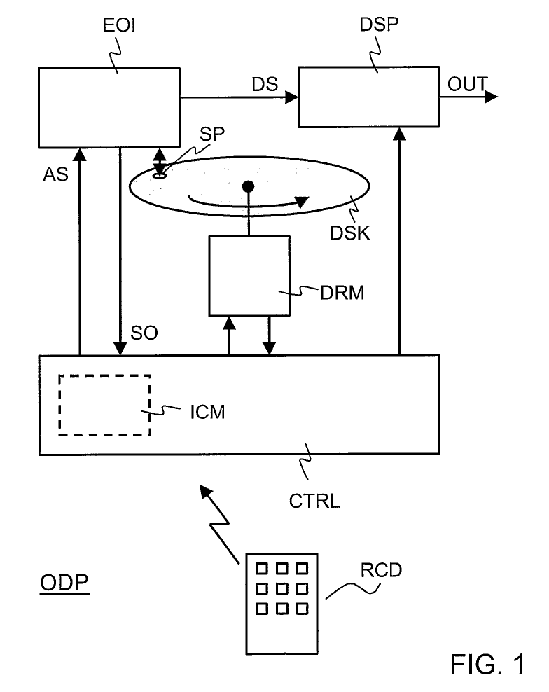

FIG. 1 illustrates an optical disk player ODP. The optical disk player ODP comprises an electro-optical interface EOI, a data signal processor DSP, a disk-rotation motor DRM, and a controller CTRL. The optical disk player ODP may further comprises a remote control device RCD. It is assumed that a disk DSK is present in the optical disk player ODP. The controller CTRL may be in the form of, for example, a programmable processor that comprises a program memory. In that case, one or more software modules, which are stored in the program memory, define operations, which the controller CTRL carries out.

The optical disk player ODP basically operates as follows. Let it be assumed that a user presses a play button on the remote control device RCD. The remote control device RCD sends a wireless signal to the controller CTRL. The controller CTRL interprets this wireless signal as a play command and, in response, causes the disk-rotation motor DRM to make the disk DSK rotate. The electro-optical interface EOI applies a light spot SP to the disk DSK, which is rotating, so as to read out data that is optically stored on the disk DSK. The electro-optical interface EOI provides a data signal DS that represents this data. The data signal processor DSP processes the data signal DS so as to obtain digital output data OUT in a suitable format. To that end, the data signal processor DSP may carry out various different types processing such as, for example, pulse detection, pulse decoding, and error decoding.

The light spot SP needs to have an appropriate size and needs to be correctly positioned on the disk DSK in order to achieve satisfactory data readout. The electro-optical interface EOI provides sensor output signals SO, which indicate the size and the position of the light spot SP. The sensor output signals SO may indicate other parameters that concern the data readout by means of the light spot SP. The controller CTRL, which receives the sensor output signals SO, establishes whether the light spot SP has the appropriate size and position or not. The controller CTRL applies actuator signals AS to the electro-optical interface EOI in response to the sensor output signals SO. The actuator signals AS, which the controller CTRL provides, cause the light spot SP to have the appropriate size and position.

FIG. 1 illustrates that the controller CTRL comprises an electro-optical interface control module ICM, which adjusts the actuator signals AS in response to the sensor output signals SO. The electro-optical interface control module ICM may be in the form of, for example, a software program. In such an implementation, the controller CTRL may comprise one or more analog-to-digital converters that convert the sensor output signals SO, which will generally be analog, into input digital values for the electro-optical interface control module ICM. The controller CTRL may further comprise one or more digital-to-analog converters that provide the actuator signals AS, which will generally be analog too, on the basis of digital output values, which the electro-optical interface control module ICM provides.

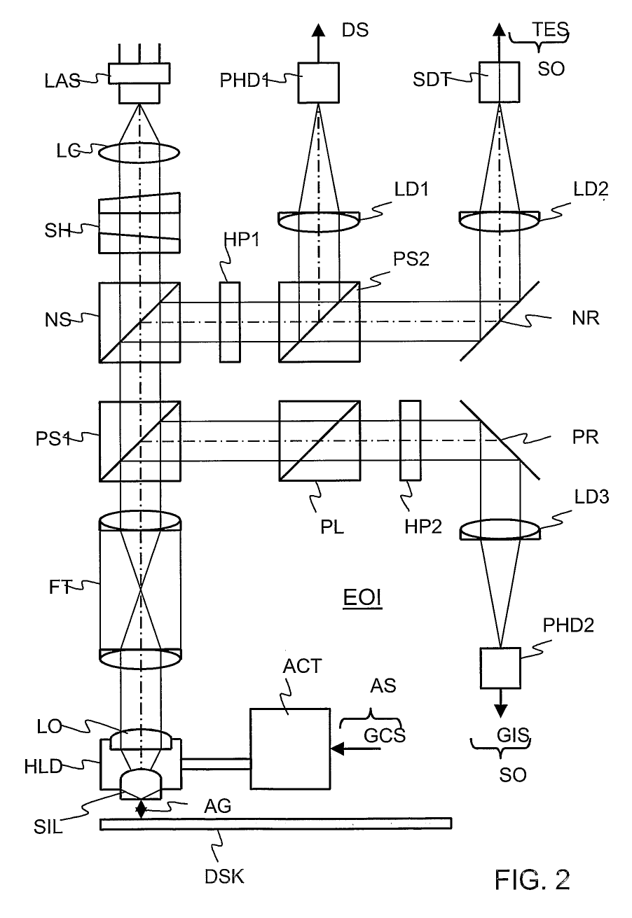

FIG. 2 illustrates the electro-optical interface EOI. The electro-optical interface EOI comprises a laser-light source LAS and various optical elements: a collimator lens LC, a beam shaper SH, a non-polarizing beam splitter NS, two polarizing beam splitters PS1, PS2, two half wave plates HP1, HP2, a polarizer PL, a non-polarizing reflector NR, a polarizing reflector PR, three detection lenses LD1, LD2, LD3, a focus-adjustment telescope FT, an objective lens LO, and a solid immersion lens SIL. The objective lens LO and the solid immersion lens SIL are mounted in a lens holder HLD, which is coupled to an actuator ACT. The electro-optical interface EOI further comprises two photodiodes PHD1, PHD2 and a split detector SDT.

The solid immersion lens SIL may be formed, for example, by combining a plano-aspherical lens, which has a numerical aperture of approximately 0.45, with a 1.0 millimeter (mm) aplanatic super-hemispherical solid immersion lens SIL made of LaSF35 glass with a refractive index of 2.086 at a wavelength of 405 nanometers (nm). The aplanatic super-hemispherical solid immersion lens SIL increases the numerical aperture of approximately 0.45 by a factor equal to the square of 2.068, which is the refractive index. Accordingly, the solid immersion lens SIL has an effective numerical aperture of approximately 1.9. This allows a relatively small spot size at a distance where evanescent light energy from the solid immersion lens SIL has decayed to a relatively small extent only.

The electro-optical interface EOI operates as follows. The laser-light source LAS produces a laser-light beam that has a wavelength of approximately 405 nm. The collimator lens LC, the beam shaper SH, the non-polarizing beam splitter NS, polarizing beam splitters PS 1, the focus-adjustment telescope FT, the objective lens LO and the solid immersion lens SIL constitute a main light path via which the laser-light beam produces the light spot SP on the disk DSK. It has been mentioned hereinbefore that the solid immersion lens SIL has a numerical aperture of approximately 1.9. This allows the light spot SP to be of relatively small size provided that the solid immersion lens SIL is relatively close to the disk DSK.

FIG. 2 illustrates an air gap AG between the solid immersion lens SIL and the disk DSK. The air gap AG should preferably be a few tens of nanometers. For example, 30 nm may be an appropriate value. The air gap AG varies as a function of a gap control signal GCS, which the actuator ACT receives. The gap control signal GCS forms part of the actuator signals AS illustrated in FIG. 1. The gap control signal GCS can cause the actuator ACT to move the lens holder HLD in a direction that is perpendicular to the disk DSK. Accordingly, the air gap AG can be decreased or increased.

The disk DSK causes a portion of the laser-light beam to be reflected back in a direction from the solid immersion lens SIL to polarizing beam splitter PS I and the non-polarizing beam splitter NS. Accordingly, the main light path comprises a reflected light component. The non-polarizing beam splitter NS, half wave plate HP1, polarizing beam splitters PS2, and detector lens LD1 form a data detection light path via which a portion of the reflected light component is projected onto photodiode PDH1. In response, photodiode PDH1 provides the data signal DS, which FIG. 1 also illustrates, and which represents data that is optically stored on the disk DSK.

The non-polarizing beam splitter NS, half wave plate HP1, polarizing beam splitter PS2, the non-polarizing reflector NR, and detector lens LD2 form a tracking error detection light path via which another portion of the reflected light component is projected onto the split detector SDT. In response, the split detector SDT provides a tracking error signal TES, which forms part of the sensor output signals SO illustrated in FIG. 1. It should be noted that, alternatively, photodiode PHD1 may comprise several segments, each of which provides a detection signal. In such an implementation, a sum of respective detection signals can form a data signal, and a difference between respective detection signals can form a tracking error signal. The split detector SDT may then be dispensed with.

Polarizing beam splitter PS1, the polarizer PL, half wave plate HP2, the polarizing reflector PR, and detector lens LD3 form a gap detection light path via which yet another portion of the reflected light component is projected onto photodiode PHD2. The portion of the reflected light component that is projected onto the photodiode PHD2 has a polarization state that is perpendicular to that of the laser-light beam, which produces the light spot SP on the disk DSK. Photodiode PHD2 provides a gap indication signal GIS, which forms part of the sensor output signals SO illustrated in FIG. 1.

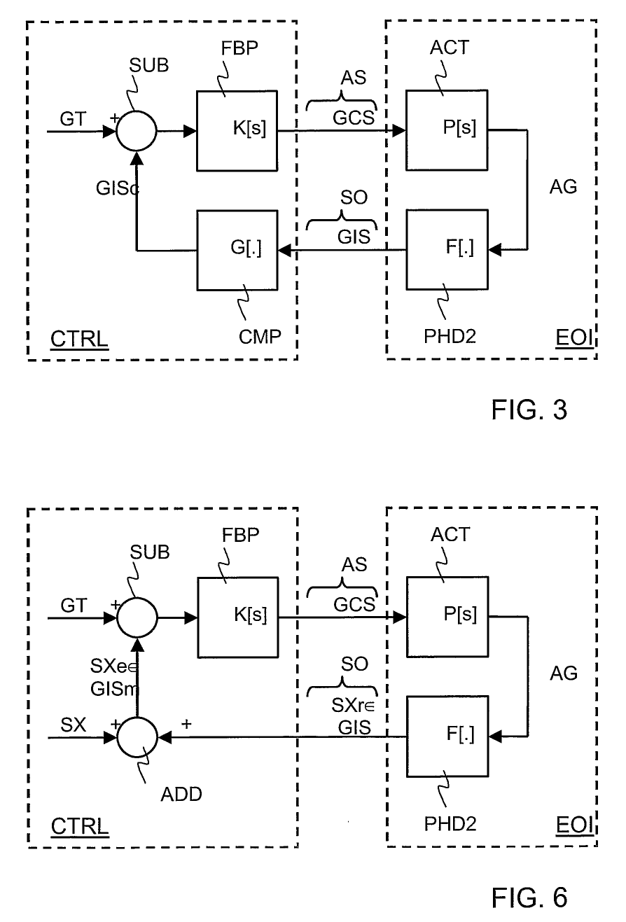

FIG. 3 illustrates a servo control loop, which causes the air gap AG to have a desired value. The controller CTRL and the electro-optical interface EOI form the servo control loop. The servo control loop comprises various loop transfer functions. In the electro-optical interface EOI, the actuator ACT has an actuator transfer function P[s]. The air gap AG varies with the gap control signal GCS in accordance with the actuator transfer function P[s]. Photodiode PHD2, which receives a portion of reflected light component via the gap detection light path as explained hereinbefore, has a gap indication transfer function F[.]. The gap indication signal GIS varies with the air gap AG in accordance with the gap indication transfer function F[.].

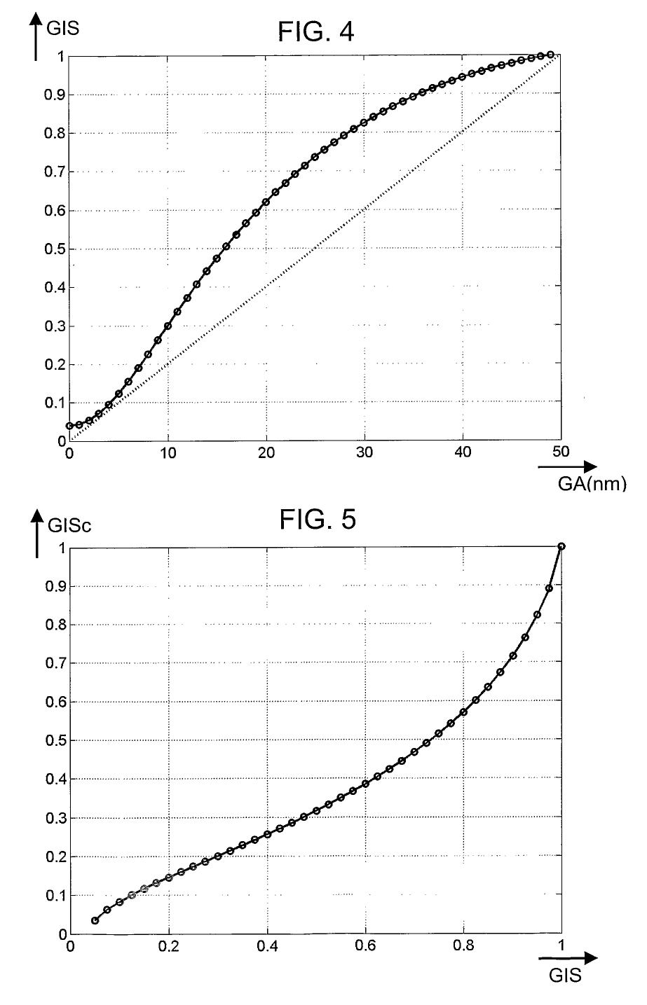

FIG. 4 illustrates the gap indication transfer function F[.]. A horizontal axis represents the air gap AG in nm units. A vertical axis represents the gap indication signal GIS in normalized units. A curve with small circles represents the gap indication transfer function F[.] in accordance with which the gap indication signal GIS varies as a function of the air gap AG. FIG. 4 illustrates that this function is substantially nonlinear. For example, the curve has a relatively steep slope at a point for which the air gap AG is 10 nm. The curve has a relatively gentle slope at a point for which the air gap AG is 40 nm.

The controller CTRL, which FIG. 3 illustrates, comprises a compensator CMP that provides a compensated gap indication signal GISc in response to the gap indication signal GIS, which photodiode PHD2 provides. The compensator CMP has a compensation transfer function G[.] in accordance with which the compensated gap indication signal GISc varies with the gap indication signal GIS. The compensation transfer function G[.] compensates for nonlinearity in the gap indication transfer function F[.]. Accordingly, the compensated gap indication signal GISc varies as a function of the air gap AG in a substantially linear fashion.

A subtractor SUB subtracts the compensated gap indication signal GISc from a gap target GT. The gap target GT is a value that represents the desired value for the air gap AG. The controller CTRL further comprises a feedback processor FBP that provides the gap control signal GCS in response to an error signal from the subtractor SUB. The feedback processor FBP has a feedback transfer function K[s] in accordance with which the gap control signal GCS varies as a function of the error signal, which represents the difference between the gap target GT and the compensated gap indication signal GISc. The servo control loop has a loop gain that is the product of the aforementioned transfer functions F[.], G[.], K[s], P[s] within the servo control loop.

FIG. 5 illustrates the compensation transfer function G[.] of the compensator CMP. A horizontal axis represents the gap indication signal GIS in normalized units. A vertical axis represents the compensated gap indication signal GISc in normalized units. A curve represents with small circles represents the compensation transfer function G[.]. The compensation transfer function G[.] allows the loop gain to be substantially constant over a range of relatively small air gaps comprised between, for example, 0 and 50 nm. Ideally, the product of the gap indication transfer function F[.], which FIG. 4 illustrates, and the compensation transfer function G[.], which FIG. 5 illustrates, would result in a curve that is a straight line. FIG. 4 illustrates that straight line.

The servo control loop, which FIG. 3 illustrates, seeks to achieve a steady state condition. In the steady state condition, the compensated gap indication signal GISc is equal to the gap target GT plus a difference, which is negligible if the loop gain is sufficiently high. Consequently, the air gap AG has the desired value, which the gap target GT represents. Let it be assumed that the air gap AG somewhat deviates from the desired value. This will cause a variation in the compensated gap indication signal GISc. The error signal, which the subtractor SUB provides, will become larger. In response, the feedback processor FBP adjusts the gap control signal GCS, which causes the actuator ACT to counteract the deviation in the air gap AG. Accordingly, the air gap AG can remain substantially constant and relatively close to the desired value.

The servo control loop reacts to an air gap deviation in a certain fashion, which is called dynamic behavior. The dynamic behavior of the servo control loop should preferably be substantially similar over a relatively wide range of possible air gaps. The dynamic behavior depends, amongst other things, on the loop gain. It has been explained hereinbefore that the loop gain is substantially constant over relatively wide range of air gaps thanks to the compensation transfer function G[.] of the compensator CMP. Accordingly, the servo control loop has a substantially similar dynamic behavior over this wide range of air gaps. Moreover, the loop gain can be relatively high without risk of oscillation so that there is little control error.

The compensator CMP can be implemented in numerous different manners. For example, the compensator CMP may be implemented by means of a lookup table. The lookup table specifies respective values that the compensated gap indication signal GISc should have for respective value of the gap indication signal GIS. Referring to FIG. 5, the respective circles on the curve, which represents the compensation transfer function G[.], may correspond with respective entries in the lookup table.

The compensator CMP may carry out an interpolation between two different entries in the lookup table, which corresponds with two different circles in FIG. 5. Accordingly, the compensator CMP can establish a value for the compensated gap indication signal GISc in response to any given value of the gap indication signal GIS within a range of values, which is comprised between extreme values in the lookup table. The lookup table may be stored in a memory, which may be volatile or nonvolatile.

In some applications, the gap indication transfer function F[.] may be known beforehand with sufficient precision. These applications rely on strict tolerances for components in the opto-electrical interface. In that case, replacing photodiode PHD2 by another photodiode of the same type will have little effect on the gap indication transfer function F[.], which remains substantially the same. In such applications, an identical compensation transfer function G[.] can be applied in each optical disk player of a batch of optical disk players of the same type. For example, an identical, predefined lookup table can be stored in each optical disk player of the batch.

In other applications, the gap indication transfer function F[.] may not be known beforehand, or may not be known with sufficient precision. In principle, it is possible to measure the gap indication transfer function F[.] of each individual optical disk player. Subsequently, an appropriate compensation transfer function G[.] can be established. The compensator CMP of the controller CTRL is then arranged to provide this compensation transfer function G[.] by means of, for example, downloading an appropriate lookup table. However, such a solution may be applied in a production chain, in his relatively time consuming and therefore relatively costly.

The controller CTRL may automatically establish an appropriate compensation transfer function G[.] when, for example, the optical disk player ODP is switched on. To that end, the controller CTRL puts the servo control loop in a measurement mode. Furthermore, the controller CTRL carries out a measurement procedure while the servo control loop is in the measurement mode. The electro-optical interface control module ICM, which FIG. 1 illustrates, may cause the controller CTRL to carry out the aforementioned functions.

FIG. 6 illustrates the servo control loop in the measurement mode, whereas FIG. 4 illustrates the servo control loop in a control mode. The controller CTRL operates differently in the measurement mode with respect to the control mode. The compensator CMP, which is illustrated in FIG. 4, is replaced by an adder ADD, which FIG. 6 illustrates. The electro-optical interface EOI operates identically in the measurement mode and the control mode.

The adder ADD receives a stimulus signal SX at an input. The stimulus signal SX may be, for example, a sinusoidal signal having a frequency in the range comprised between 100 Hz and 1 kHz. The adder ADD injects the stimulus signal SX, as it were, into the servo control loop. In response, the servo control loop provides a stimulus response signal SXr, which is present at another input of the adder ADD. The adder ADD provides a stimulus error signal SXe, which is a difference between the stimulus signal SX and the stimulus response signal SXr.

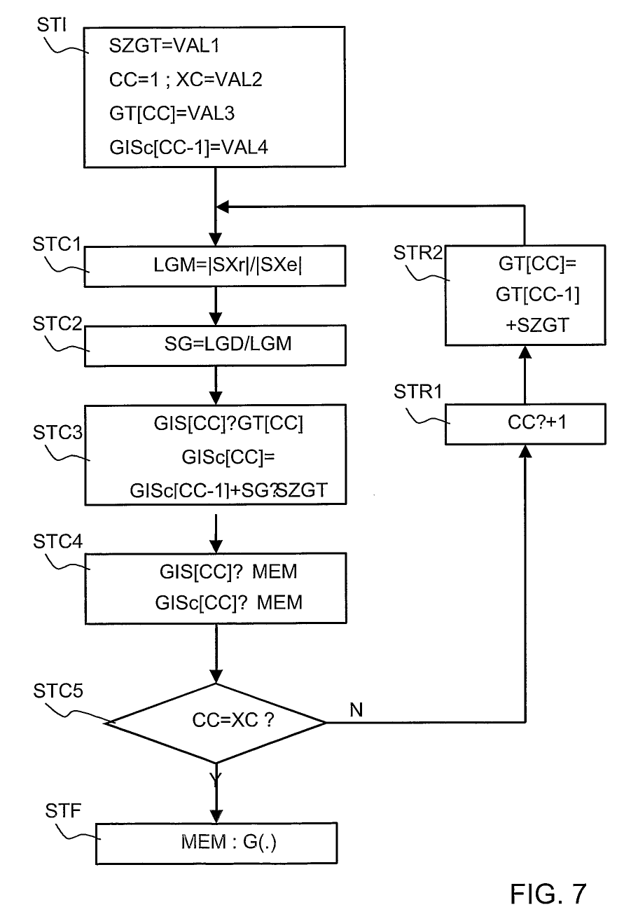

FIG. 7 illustrates the measurement procedure, which the controller CTRL carries out while the servo control loop is in the measurement mode. The measurement procedure comprises an initial step STI, five measurement cycle steps STC1-STC5, two return steps STR1, STR2, and a final step STF. The five measurement cycle steps STC1-STC5 constitute a measurement cycle. The two return steps STR1, STR2 constitute a preparation of a new measurement cycle. The controller CTRL carries out various measurement cycles, which means that the controller CTRL carries out the five measurement cycle steps STC1-STC5 and, subsequently, the two return steps STR1, STR2 several times.

In the initial step STI, the controller CTRL gives various respective parameters respective initial values. The measurement procedure includes the following parameters: a gap target step size SZGT, which is a fixed parameter, a current cycle number CC, a last cycle number XC, a gap target for the current cycle GT[CC], and a value for the compensated gap indication signal in the previous cycle GISc[CC-1], which are running parameters. The current cycle number CC is given the value 1. The gap target step size SZGT, the last cycle number XC, the gap target for the current cycle GT[CC], and the value for the compensated gap indication signal in the previous cycle GISc[CC-1] are given initial values, VAL1, VAL2, VAL3, and VAL4 respectively.

In measurement cycle step STC1, the controller CTRL establishes a measured loop gain LGM. The measured loop gain LGM is the ratio between the amplitude of the stimulus response signal |SXr| and the amplitude of stimulus error signal |SXe|. FIG. 6 illustrates that the stimulus response signal SXr corresponds with the stimulus error signal SXe applied to the product of the feedback transfer function K[s], the actuator transfer function P[s], and the gap indication transfer function F[.]. The absolute value of this product corresponds with the measured loop gain LGM. The measured loop gain LGM applies to the gap target for the current cycle GT[CC]. Each measurement cycle has a different gap target. The measured loop gain LGM for one gap target may differ from that for another gap target. This is due to the nonlinearity of the gap indication transfer function F[.], which FIG. 4 illustrates.

In measurement cycle step STC2, the controller CTRL establishes a compensation function slope SG. The compensation function slope SG is the ratio between a desired loop gain LGD and the measured loop gain LGM. The desired loop gain LGD may be a predefined value, which applies to each measurement cycle. Moreover, the desired loop gain LGD may apply to various different measurement procedures that the controller CTRL carries out. The compensation function slope SG corresponds with the first derivative that the compensation transfer function G[.] should have for the average value of the gap indication signal in the current cycle GIS[CC].

In measurement cycle step STC3, the controller CTRL establishes the average value of the gap indication signal in the current cycle GIS[CC]. The average value corresponds with the direct-current component of the gap indication signal GIS. The average value of the gap indication signal in the current cycle GIS[CC] is substantially equal to the gap target for the current cycle GT[CC] if the loop gain is sufficiently high. That is, the controller CTRL need not measure the average value of the gap indication signal GIS[CC].

In measurement cycle step STC3, the controller CTRL further establishes a value for the compensated gap indication signal GISc[CC], which applies to the current cycle. The compensation transfer function G[.] should provide this value in response to the average value of the gap indication signal in the current cycle GIS[CC]. This corresponds with, for example, a circle on the curve in that FIG. 5 illustrates. The value for the compensated gain indication signal in the current cycle GISc[CC] is equal to the value for the compensated gain indication signal in the previous cycle GISc[CC-1] plus the gap target step size SZGT multiplied by the compensation transfer function slope SG, which has been established in measurement cycle step STC2.

In measurement cycle step STC4, the controller CTRL stores the following two results in a memory: the average value of the gap indication signal in the current cycle GIS[CC] and the value for the compensated gap indication signal in the current cycle GISc[CC]. These respective values corresponds with, for example, a circle on the curve in FIG. 5. The average value of the gap indication signal GIS[CC] corresponds with a point on the horizontal axis in FIG. 5. The value of the compensated gap indication signal GISc[CC] corresponds with a point on the vertical axis.

In measurement cycle step STC5, the controller CTRL checks whether the current cycle number CC is the last cycle number XC or not. Let it be assumed that the current cycle number CC is the last cycle number XC. In that case, the controller CTRL carries out the final step STF. In contradistinction, let it now be assumed that the current cycle number CC is not the last cycle number XC. In that case, the controller CTRL carries out the two return steps STR1, STR2 and, subsequently, will carries out the five measurement cycle steps STC1-STC5 anew.

In return step STR1, the controller CTRL increments the value of the current cycle number CC by one unit. Consequently, the five measurement cycle steps STC1 -STC5 which have just been carried, become the previous measurement cycle. The five measurement cycle steps STC1-STC5, which will subsequently be carried out, become the current measurement cycle.

In return step STR2, the controller CTRL establishes the gap target for the current cycle GT[CC], which will apply to the five measurement cycle steps STC1-STC5 that will subsequently be carried out. The gap target for the current cycle GT[CC] is equal to the gap target for the previous cycle GT[CC-1] plus the gap target step size SZGT. The controller CTRL is now ready to carry out a new measurement cycle for a new gap target. Referring to FIG. 5, the gap target for the current cycle GT[CC] can be considered as a cursor on the horizontal axis. The cursor is shifted to the right each time return step is carried out, which is followed by the five measurement cycle steps STC1-STC5.

In the final step STF, the controller CTRL establishes the compensation transfer function G[.] on the basis of respective average values of the gap indication signal GIS and respective desired values of the compensated gap indication signal GISc, which have been established in respective measurement cycles and stored in the memory in measurement cycle step STC4 in each respective measurement cycle.

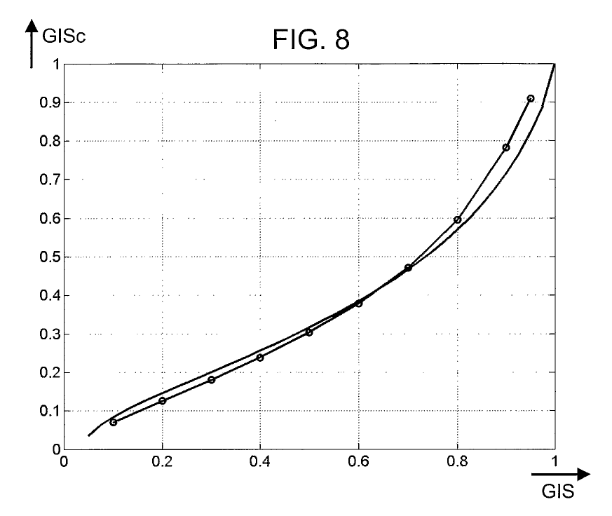

FIG. 8 illustrates a compensation transfer function G[.], which has been established in accordance with the measurement procedure illustrated in FIG. 7. A horizontal axis represents the gap indication signal GIS. A vertical axis represents the compensated gap indication signal GISc. A curve with small circles represents the compensation transfer function G[.] that has been established. There is another curve, without small circles, which represents an ideal compensation transfer function G[.].

A small circle corresponds with a measurement cycle. The left-most small circle corresponds with a first measurement cycle, the one but left-most small circle corresponds with a second measurement cycle, and so on. The right-most small circle corresponds with a last measurement cycle. The gap target GT in the first measurement cycle is 0.1, which corresponds with the value of the gap indication signal GIS for the left -most small circle. The gap target GT increases by 0.1 with each measurement cycle. That is, the target step size is 0.1.

In the first measurement cycle, a value of approximately 0.08 has been established for the compensated gap indication signal GISc. In the second measurement cycle, the first derivative of the compensation transfer function G[.] has first been established for the value 0.2 on the horizontal axis. The compensated gap indication signal GISc has a value, which has been calculated as follows. The gap target step size SZGT multiplied by the aforementioned first derivative has been added to the value 0.08, which has been established for the compensated gap indication signal GISc in the first measurement cycle. That is, the measurement procedure that FIG. 7 illustrates gradually builds, as it were, the compensation transfer function G[.] on the basis of respective first derivatives, which are obtained by loop gain measurement.

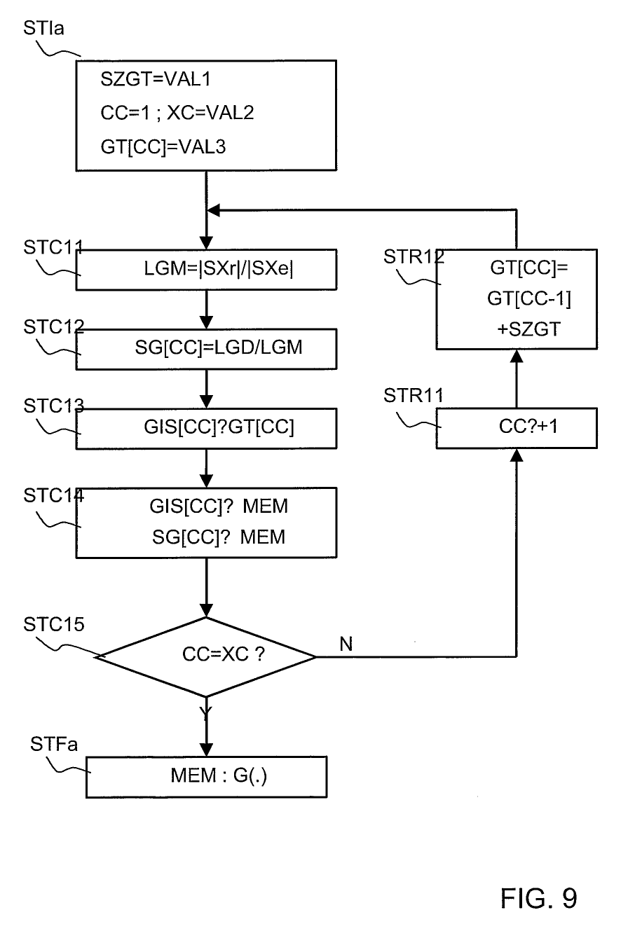

FIG. 9 illustrates an alternative measurement procedure, which the controller CTRL may carry out while the servo control loop is in the measurement mode. The alternative measurement procedure comprises an alternative initial step STIa, five measurement cycle steps STC11-STC15, two return steps STR11, STR12, and an alternative final step STFa.

In the alternative initial step STIa, the controller CTRL gives the gap target step size SZGT, the last cycle number XC, and the gap target for the current cycle GT[CC] initial values, VAL1, VAL2, and VAL3, respectively.

In measurement cycle step STC11, the controller CTRL establishes the measured loop gain LGM in a manner identical to that in measurement cycle step STC1 described hereinbefore with reference to FIG. 7.

In measurement cycle step STC12, the controller CTRL establishes the compensation function slope in the current cycle SG[CC] in a manner identical to that in measurement cycle step STC2 described hereinbefore with reference to FIG. 7.

In measurement cycle step STC13, the controller CTRL establishes the average value of the gap indication signal in the current cycle GIS[CC] in a manner identical to that in measurement cycle step STC3 described hereinbefore with reference to FIG. 7.

In measurement cycle step STC14, the controller CTRL stores the following two results in a memory: the average value of the gap indication signal in the current cycle GIS[CC] and the compensation function slope in the current cycle SG[CC].

In measurement cycle step STC15, the controller CTRL checks whether the current cycle number CC is the last cycle number XC or not. Measurement cycle step STC15 is identical to measurement cycle step STC5 described hereinbefore with reference to FIG. 7.

Return steps STR11 and STR12 are identical to return steps STR1 and STR2, respectively, described hereinbefore with reference to FIG. 7.

In the alternative final step STFa, the controller CTRL establishes the compensation transfer function G[.] on the basis of respective average values of the gap indication signal GIS and respective compensation function slopes SG, which have been established in respective measurement cycles and stored in the memory in measurement cycle step STC14 in each respective measurement cycle.

Concluding Remarks:

The detailed description hereinbefore with reference to the drawings illustrates the following characteristics, which are cited in various independent claims. A spot-forming lens (SIL) projects a light spot (SP) on an optical information carrier (DSK) in response to a light beam from a light source (LAS). There is an air gap (AG) between the spot-forming lens (SIL) and the optical information carrier (DSK). A gap detector (PHD2) provides a gap indication signal (GIS) that varies with the air gap (AG) in accordance with a gap indication transfer function (F). A lens-positioning arrangement (CTRL, ACT) positions the spot-forming lens (SIL) with respect to the optical information carrier (DSK) on the basis of the gap indication signal (GIS). The lens-positioning arrangement (CTRL, ACT) comprises a compensator (CMP) for compensating nonlinearity in the gap indication transfer function (F).

The detailed description hereinbefore further illustrates various optional characteristics, which are cited in the dependent claims. These characteristics may be applied to advantage in combination with the aforementioned characteristics. Various optional characteristics are highlighted in the following paragraphs. Each paragraph corresponds with a particular dependent claim.

The compensator (CMP) compensates the nonlinearity in the gap indication transfer function (F) for air gaps smaller than half the wavelength of the light beam, which is used to project the light spot (SP) on the optical information carrier (DSK). This allows reliable and robust high-density data read out in near-field optical systems.

The compensator (CMP) provides a compensated gap indication signal (GIS) in response to the gap indication signal (GIS), which the gap detector (PHD2) provides. A comparator (SUB) compares the compensated gap indication signal (GIS) with a gap target (GT) so as to obtain an error signal. A feedback processor (FBP) provides an actuator signal (GCS) in response to the error signal. An actuator (ACT) adjusts the air gap (AG) between the spot-forming lens (SIL) and the optical information carrier (DSK) in response to the actuator signal (GCS). This allows a relatively accurate air gap control, which further contributes to reliable and robust data readout and data recording.

The compensator (CMP), the comparator (SUB), and the feedback processor (FBP) are implemented as a programmed processor. This allows flexibility and cost efficiency.

The lens-positioning arrangement (CTRL, ACT) and the gap detector (PHD2) form a servo control loop. A measurement module (ICM) carries out respective servo control loop measurements for respective values of the air gap (AG). The measurement module (ICM) further establishes a compensation transfer function (G) on the basis of the respective servo control loop measurements. This allows a relatively accurate compensation of the nonlinearity in the gap indication transfer function, even if the gap indication transfer function is not known beforehand, which further contributes to reliable and robust data readout and data recording. Moreover, a calibration during a manufacturing process is not required, which contributes to cost efficiency.

The measurement module (ICM) may cause a controller (CTRL) to carry out the following steps. In a loop gain measurement step (STC1; STC11), respective loop gain measurements are carried out for respective values of the air gap (AG). In a slope determining step (STC2; STC12), respective compensation function slopes (SG) are determined for respective air gaps (AG). A compensation function slope (SG) is determined on the basis of a measured loop gain (LGM) for a particular value of the air gap (AG). The compensation function slope (SG) corresponds with a slope of the compensation transfer function (G) at the particular value of the air gap (AG). In a compensation transfer function establishing step (STC3; STFa), the compensation transfer function (G) is established on the basis of the respective compensation function slopes (SG).

The aforementioned characteristics can be implemented in numerous different manners. In order to illustrate this, some alternatives are briefly indicated.

The aforementioned characteristics may be applied to advantage in any type of product or method that relates to optical data storage. An optical disk player is merely an example. The aforementioned characteristics may equally be applied in, for example, an optical disk recorder, which may also read data from an optical disk. Referring to FIG. 2, the laser-light source LAS may produce a relatively high-power laser light beam so as to alter a physical property on the optical disk.

The gap detector can be implemented in numerous different manners. FIG. 2 merely illustrates an example, in which photo detector PHD2 provides the gap indication signal GIS. As another example, is possible to derive a gap indication signal from photo detector PHD1, which provides the data signal DS, by means of filtering or signal separation techniques.

Yet another way to obtain a gap indication signal is as follows. A laser-light source emits a laser beam having an initial polarization state that is linear. The laser beam is passed through a quarter wave plate so as to obtain a laser beam whose polarization is in a circular state. The laser beam that has passed the quarter wave plate illuminates an objective lens. Subsequently, a portion of a reflected laser beam, which emanates from the objective lens, is passed through a quarter wave plate, which can be the same as the aforementioned one or a different one, and through a polarizing element, such as, for example, a polarizing beam splitter or a polarizing absorber. Accordingly, a reflected laser beam is obtained that has a polarization state parallel to that of the initial polarization state. This last-mentioned reflected laser beam is detected, which results in the gap indication signal.

The spot-forming lens can be implemented in numerous different manners. A solid immersion lens is merely an example. A solid immersion mirror is another example. Aperture probes have also been proposed for near-field optical systems.

The lens-positioning arrangement can be implemented in numerous different manners. The lens-positioning arrangement can be software-based in which a suitably programmed processor causes the spot-forming lens to be appropriately positioned with respect to the optical information carrier. This is a software-based solution. Alternatively, a dedicated circuit, which may be analog or digital, or both, may also appropriately position the spot-forming lens in response to the gap indication signal. For example, the compensator, the substructure, and the feedback processor, which FIG. 3 illustrates, may be implemented by means of one or more dedicated circuits.

There are numerous different manners to implement the compensator, which compensates for the nonlinearity in the gap indication transfer function. An implementation that is based on a lookup table is merely an example. As another example, the compensator may be based on a non-linear function that comprises various respective predefined terms (x, x², x³, . . . ) with various respective coefficients (a, b, c, . . . ) that define the compensation transfer function. The compensator need not necessarily be located as illustrated in FIG. 3. For example, referring to FIG. 3, the compensator CMP may be arranged between the subtractor SUB and the feedback processor FBP instead of being arranged between photodiode PHD2 and the subtractor SUB. As another example, the compensator CMP may also be replaced by an equivalent compensator arranged between the feedback processor FBP and the actuator ACT.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. An optical storage interface apparatus (ODP) comprising:
a spot-forming lens (SIL) arranged to project a light spot (SP) on an optical information carrier (DSK) in response to a light beam from a light source (LAS);
a gap detector (PHD2) arranged to provide a gap indication signal (GIS) which varies with an air gap (AG) between the spot-forming lens (SIL) and the optical information carrier (DSK) in accordance with a gap indication transfer function (F); and
a lens-positioning arrangement (CTRL, ACT) arranged to position the spot-forming lens (SIL) with respect to the optical information carrier (DSK) on the basis of the gap indication signal (GIS), the lens-positioning arrangement (CTRL, ACT) comprising a compensator (CMP) for compensating a nonlinearity in the gap indication transfer function (F).

2. An optical storage interface apparatus according to claim 1, the compensator (CMP) being arranged to compensate the nonlinearity in the gap indication transfer function (F) for air gaps smaller than half the wavelength of the light beam, which is used to project the light spot (SP) on the optical information carrier (DSK).

3. An optical storage interface apparatus according to claim 2, the compensator (CMP) being arranged to provide a compensated gap indication signal (GIS) in response to the gap indication signal (GIS), which the gap detector (PHD2) provides, the lens positioning system comprising:
a comparator (SUB) for comparing the compensated gap indication signal (GIS) with a gap target (GT) so as to obtain an error signal;
a feedback processor arranged to provide an actuator signal (GCS) in response to the error signal; and
an actuator (ACT) arranged to adjust the air gap (AG) between the spot-forming lens (SIL) and the optical information carrier (DSK) in response to the actuator signal (GCS).

4. An optical storage interface apparatus according to claim 3, the compensator (CMP), the comparator (SUB), and the feedback processor being implemented as a programmed processor.

5. An optical storage interface apparatus according to claim 1, the lens-positioning arrangement (CTRL, ACT) and the gap detector (PHD2) forming a servo control loop, the optical storage interface comprising a measurement module (ICM) for carrying out respective servo control loop measurements for respective values of the air gap (AG), and for establishing a compensation transfer function (G) on the basis of the respective servo control loop measurements.

6. An optical storage interface apparatus according to claim 1, the spot-forming lens (SIL) comprising a solid immersion lens, which has a numerical aperture greater than 1.

7. An optical storage interface apparatus according to claim 1, the gap detector comprising a gap detection light path (PS1, PL, HP2, PR, LD3) and a photo detector (PHD2), the gap detection light path (PS1, PL, HP2, PR, LD3) being arranged to project onto the photo detector (PHD2) a portion of a reflection of the light beam by the optical information carrier (DSK) via the spot-forming lens (SIL).

8. An optical storage interface apparatus according to claim 7, the gap detection light path (PS1, PL, HP2, PR, LD3) being arranged so that the portion of the reflection, which is projected onto the photo detector (PHD2), is substantially perpendicular to another portion of the reflection, which is projected onto another photo detector (PHD 1) via a data detection light path (NS, HP1, PS2, LD1) for detecting data that is stored on the optical information carrier (DSK).

9. A method of controlling an optical storage interface that comprises:
a spot-forming lens (SIL) arranged to project a light spot (SP) on an optical information carrier (DSK) in response to a light beam from a light source (LAS); and
a gap detector (PHD2) arranged to provide a gap indication signal (GIS) which varies with an air gap (AG) between the spot-forming lens (SIL) and the optical information carrier (DSK) in accordance with a gap indication transfer function (F),
the method comprising:
a lens-positioning step in which the spot-forming lens (SIL) is positioned with respect to the optical information carrier (DSK) on the basis of the gap indication signal (GIS), the lens-positioning step comprising a compensation sub-step in which a nonlinearity in the gap indication transfer function (F) is compensated for.

10. A method of controlling an optical storage interface according to claim 9, the method comprising:
a measurement step (STI, STC1-STC5, STR1, STR2, STF) in which respective servo control loop measurements are carried out for respective values of the air gap (AG), and in which a compensation transfer function is established (G) on the basis of the respective servo control loop measurements.

11. A method of controlling an optical storage interface according to claim 10, the measurement step (STI, STC1-STC5, STR1, STR2, STF) comprising:
a loop gain measurement step (STC1) in which respective loop gain measurements are carried out for respective values of the air gap (AG);
a slope determining step (STC2) in which respective compensation function slopes (SG) are determined for respective air gaps (AG), a compensation function slope (SG) being determined on the basis of a measured loop gain (LGM) for a particular value of the air gap (AG), the compensation function slope (SG) corresponding with a slope of the compensation transfer function (G) at the particular value of the air gap (AG); and
a compensation transfer function establishing step (STC3) in which the compensation transfer function (G) is established on the basis of the respective compensation function slopes (SG).

12. A computer program product for an optical storage interface that comprises:
a spot-forming lens (SIL) arranged to project a light spot (SP) on an optical information carrier (DSK) in response to a light beam from a light source (LAS); and
a gap detector (PHD2) arranged to provide a gap indication signal (GIS) which varies with an air gap (AG) between the spot-forming lens (SIL) and the optical information carrier (DSK) in accordance with a gap indication transfer function (F),
the computer program product comprising a set of instructions that, when loaded into the optical storage interface, causes the optical storage interface to carry out a method according to claim 9.
